(19) United States
(12) Patent Application Publication
(10) Pub. No.: US 2015/0288014 A1
(43) Pub. Date: Oct. 8, 2015

(54) APPARATUS AND METHOD FOR CONTROLLING COOLANT TEMPERATURE OF FUEL CELL SYSTEM

(71) Applicants: Hyundai Motor Company, Seoul (KR); Kia Motor Company, Seoul (KR)

(72) Inventors: Sung Wook Na, Yongin (KR); Sang Uk Kwon, Suwon (KR); Hun Woo Park, Namyangju (KR)

(21) Appl. No.: 14/745,905

(22) Filed: Jun. 22, 2015

Related U.S. Application Data
(62) Division of application No. 13/846,250, filed on Mar. 18, 2013.

(30) Foreign Application Priority Data
Dec. 14, 2012 (KR) 10-2012-0145858

(51) Int. Cl. H01M 8/04

(52) U.S. Cl. CPC H01M 8/04723; H01M 8/04358

(57) ABSTRACT

Disclosed is an apparatus and method that controls a coolant temperature of a fuel cell system, which can improve fuel efficiency by performing a multi-point temperature control based on the power of a vehicle, the outdoor temperature for each season, etc.

### CROSS-REFERENCE TO RELATED APPLICATION

This application claims under 35 U.S.C. §119(a) the benefit of Korean Patent Application No. 10-2012-0145858 filed Dec. 14, 2012, the entire contents of which are incorporated herein by reference.

### BACKGROUND

(a) Technical Field

The present invention relates to an apparatus and method that controls a coolant temperature of a fuel cell system, which can improve fuel efficiency by properly maintaining the coolant temperature.

(b) Background Art

In general, a fuel cell system is a device that converts hydrogen fuel into electrical energy through an electrochemical reaction between hydrogen and oxygen in the air and has advantages of less noise and vibration than internal combustion engines, high energy efficiency, and no contaminants. Thus, extensive research and development aimed at applying the fuel cell system to next-generation environment-friendly vehicles has continued to progress.

In particular, fuel cell systems generate water and heat as by-products as well as electrical energy through the electrochemical reaction and thus necessarily include a thermal management system (TMS) that removes heat from a fuel cell stack to the outside of the fuel cell system, controls operation temperature of the fuel cell stack, and performs water management function.

FIG. 1A is a schematic diagram showing a conventional thermal management system for a fuel cell system in a fuel cell vehicle. The thermal management system for the fuel cell system includes a radiator 2 (or a heat exchanger) configured to dissipate heat from coolant, which passes through a fuel cell stack 1, to the outside, a coolant pump 3 configured to pump the coolant, coolant lines 5 and 6 configured to provide a flow path for the coolant, and a 3-way valve 4 configured to shift the flow path of the coolant based on the temperature of the coolant.

The coolant lines 5 and 6 include a circulation line 5, which connects the fuel cell stack 1 and the radiator 2 so that the coolant is circulated through the radiator 2, and a bypass line 6, which allows the coolant discharged from the fuel cell stack 1 to bypass the radiator 2 and to be fed back to the fuel cell stack 1. The 3-way valve 4 is installed in the coolant lines 5 and 6 that meet the bypass line 6 behind the radiator 2.

Here, it is necessary to control the operation temperature of the fuel cell stack to be maintained at an optimum level. Conventionally, the temperature of the coolant introduced through a fuel cell stack inlet is measured, and the coolant temperature at the fuel cell stack inlet is controlled to a specific temperature.

The above-described method for controlling the operation temperature of the fuel cell system using the coolant will be described in more detail below. Before the coolant temperature of the fuel cell stack inlet rises to an optimum temperature for the fuel cell stack, the coolant is controlled to bypass the radiator 2 using the 3-way valve 4 and, when the coolant temperature rises above the optimum temperature, the coolant is passed through the radiator 2 using the 3-way valve 4 (e.g. a thermostat) such that the temperature of the fuel cell stack 1 is controlled by heat transfer between the radiator 2 and the heated coolant.

FIG. 1B is a schematic diagram showing an alternative position of the pump of FIG. 1A and, as shown in FIG. 1 B, the position of the pump 3 may be located between the 3-way valve 4 and the fuel cell stack 1.

However, in the case where the operation temperature of the fuel cell system (i.e., the stack inlet coolant temperature) is controlled to a specific temperature (i.e., a one-point temperature control) using the 3-way valve 4 in the above manner, a deviation in fuel efficiency occurs depending on the time of year (season) and the operation mode (downtown, highway, etc.), which is problematic.

The above information disclosed in this Background section is only for enhancement of understanding of the background of the invention and therefore it may contain information that does not form the prior art that is already known in this country to a person of ordinary skill in the art.

### SUMMARY

The present invention provides an apparatus and method configured to control a coolant temperature of a fuel cell system, which can improve fuel efficiency by performing a multi-point temperature control based on the power of a vehicle, the outdoor temperature for each season, etc.

In one aspect, the present invention provides an apparatus configured to control a coolant temperature of a fuel cell system, the apparatus including: a valve installed in a coolant line to provide a flow path for the coolant; a fuel cell controller configured to variably control a target stack inlet coolant temperature based on a control factor; and a controller configured to receive a control signal from the fuel cell controller and controlling the valve based on the control signal; wherein an operation temperature of the fuel cell system is controlled via a multi-point temperature control based on power from a vehicle and an outdoor temperature associated with each season to improve fuel efficiency.

In an exemplary embodiment, the valve may be a 3-way proportional valve operated by an electric actuator and may be configured to control a stack inlet coolant temperature by controlling an opening degree of the 3-way proportional valve.

In another exemplary embodiment, the control factor may include at least one selected from the group consisting of an outdoor temperature, a stack heat generation rate, a stack outlet coolant temperature, duration, and a combination thereof.

In another aspect, the present invention provides a method for controlling a coolant temperature of a fuel cell system, the method including: measuring the coolant temperature at an inlet of a fuel cell stack (i.e., a stack inlet coolant temperature); variably controlling a target stack inlet coolant temperature based on a control factor; comparing a measured value of the stack inlet coolant temperature and a predetermined value of the target stack inlet coolant temperature; and controlling, when the measured value of the stack inlet coolant temperature is higher than the predetermined value of the target stack inlet coolant temperature, an opening degree of a 3-way proportional valve to follow a target coolant temperature, wherein the operation temperature of the fuel cell system is controlled through a multi-point temperature control based on the power of a vehicle and an outdoor temperature (i.e., heat dissipation performance) for each season to improve fuel efficiency. Additionally, the target coolant temperature may vary depending on the outdoor temperature.

In another exemplary embodiment, the target coolant temperature may vary depending on a stack heat generation rate, a stack outlet coolant temperature, and duration of the stack heat generation rate and the stack outlet coolant temperature.

In still another exemplary embodiment, the method may further include: measuring a stack heat generation rate, a stack outlet coolant temperature, and a duration of the stack heat generation rate and the stack outlet coolant temperature; and receiving, at a fuel cell controller, the stack heat generation rate, the stack outlet coolant temperature, and the duration of the stack heat generation rate and the stack outlet coolant temperature and, when the stack heat generation rate, the stack outlet coolant temperature, and the duration of the stack heat generation rate and the stack outlet coolant temperature satisfy control entry conditions, directly controlling the opening degree of the 3-way proportional valve through a feedforward control to follow an opening command value.

In yet another exemplary embodiment, the control entry conditions may be established by comparing the stack heat generation rate, the stack outlet coolant temperature, and the duration of the stack heat generation rate and the stack outlet coolant temperature with a reference value thereof, respectively.

In still yet another exemplary embodiment, the stack heat generation rate, the stack outlet coolant temperature, the duration of the stack heat generation rate and the stack outlet coolant temperature opening, and the opening command value may be variable depending on the outdoor temperature.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1A is a schematic diagram showing a conventional thermal management system for a fuel cell system in a fuel cell vehicle;

FIG. 1B is a schematic diagram showing an alternative position of the pump of FIG. 1A;

FIG. 2 is a perspective view showing an electronic 3-way proportional valve in accordance with the present invention;

FIG. 3 is a structure diagram showing a target stack inlet temperature-based PI control in accordance with an exemplary embodiment of the present invention;

FIG. 4 is a graph showing a target stack inlet temperature map in FIG. 3; and

FIG. 5 is a structure diagram showing a stack heat generation rate-based feedforward control in accordance with another exemplary embodiment of the present invention.

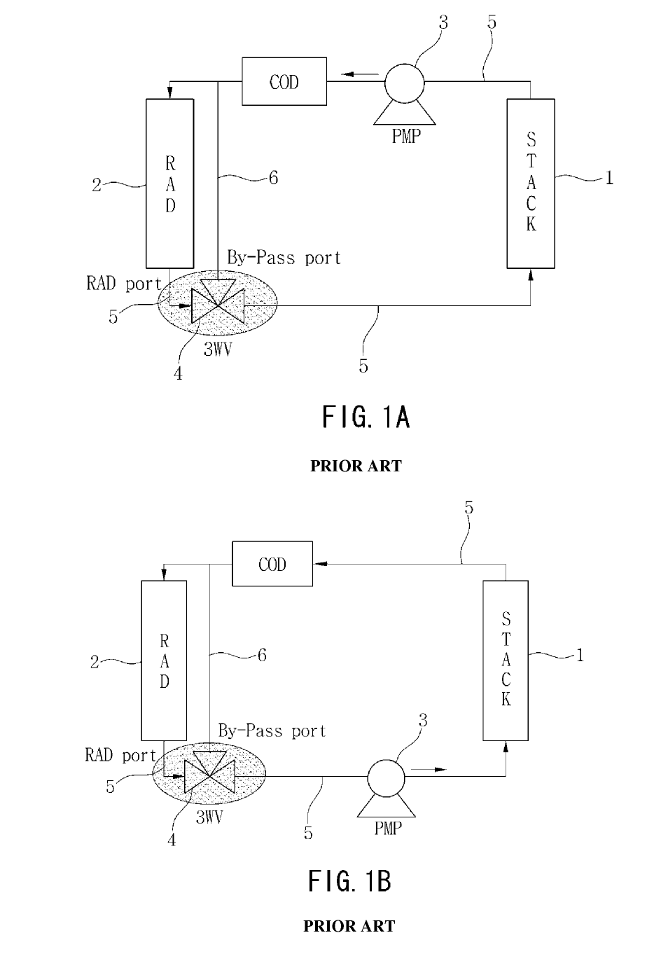

Reference numerals set forth in the Drawings includes reference to the following elements as further discussed below:

| | |
|---|---|
| 11: fuel cell stack | 12: radiator |
| 13: 3-way proportional valve | 14: coolant pump |
| 15: temperature sensor | 16: circulation line |
| 17: bypass line | 18: FCU |
| 19: controller | 20: electric actuator |
| 21: valve housing | 22: first coolant inlet |
| 23: second coolant inlet | 24: coolant outlet |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that the below methods are executed by at least one controller. The term controller refers to a hardware device that includes a memory and a processor. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The present invention provides an apparatus and method that are configured to control a coolant temperature of a fuel cell system, which can improve fuel efficiency by controlling the coolant temperature at a fuel cell stack inlet in a fuel cell vehicle based on a variety of parameters such as the power of the vehicle, the outdoor temperature, etc., instead of a specific temperature like is used in a conventional method.

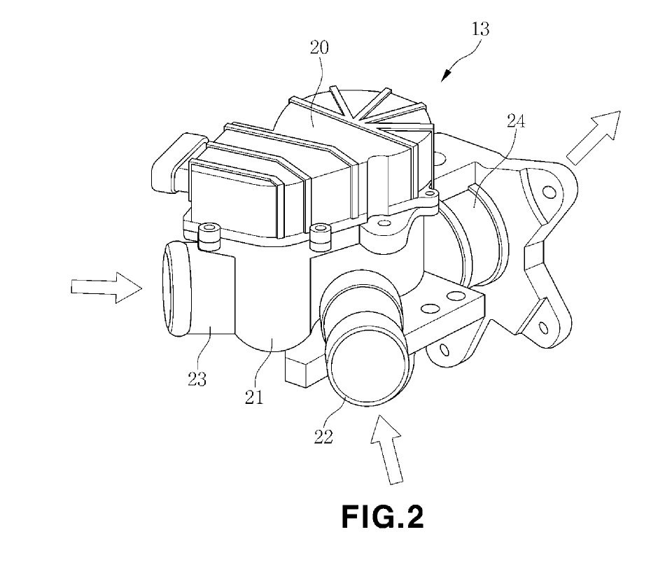

FIG. 2 is a perspective view showing a valve (e.g., an electronic 3-way proportional valve) in accordance with the present invention. An apparatus for controlling a coolant temperature of a fuel cell system in accordance with the present invention includes a temperature sensor 15, a controller 19, a fuel cell controller (FCU) 18, a radiator 12, a coolant pump 14, a control valve 13, etc.

The temperature sensor 15 is installed at an inlet of a fuel cell stack 11 to measure the temperature of coolant introduced through the inlet of the fuel cell stack 11 and may be selected from those capable of measuring the coolant temperature without particular limitations. Additionally, the radiator 12 and the coolant pump 14 are the same as those included in a thermal management system for a conventional fuel cell system, and thus a detailed description thereof will be omitted.

The control valve 13 may be a 3-way proportional valve including a valve housing 21, 2-way coolant inlets, and a 1-way coolant outlet 24. The 2-way coolant inlets include a first coolant inlet 22 connected to a bypass line, through which the coolant discharged from an outlet of the fuel cell stack 11 and bypassing the radiator 12 is introduced, and a second coolant inlet 23 connected to a circulation line 16, through which the coolant discharged from the outlet of the fuel cell stack 11 and passing through the radiator 12 is introduced. The 1-way coolant outlet 24 is connected to the inlet of the fuel cell stack 11 to supply the coolant introduced into the housing 21 to the inlet of the fuel cell stack 11.

A coolant flow control valve may be rotatably installed in the 3-way proportional valve 13 to be rotated by an electric actuator 20, e.g., an electric motor, to control the opening degree of the valve based on the rotation direction. For example, the coolant flow control valve may rotate to open the first coolant inlet 22 or the second coolant inlet 23 and, when both of the first and second coolant inlets 23 and 23 are opened, the ratio of the first and second coolant inlets 23 and 23 may be changed. At this time, the electric motor may receive a control signal from the controller 19 to control the rotation angle of the coolant flow control valve based on the power of the vehicle, the outdoor temperature for each season, etc.

The FCU 18 is a high level controller that is configured to control the overall control of the coolant temperature based on the operating conditions of the fuel cell system in the fuel cell vehicle. The controller 19, on the other hand, receives a control signal from the FCU 18 to control the overall operation of the 3-way proportional valve 13.

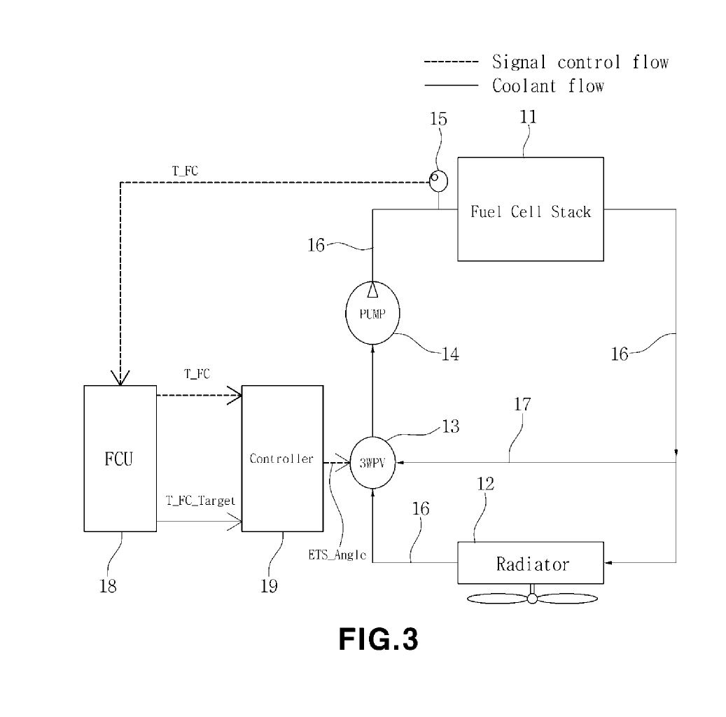

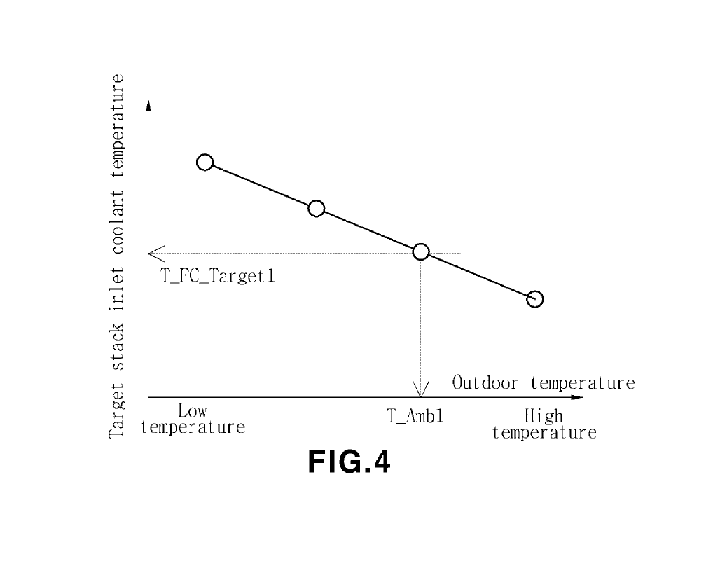

FIG. 3 is a structure diagram showing a target stack inlet temperature-based PI control in accordance with an exemplary embodiment of the present invention, and FIG. 4 is a graph showing a target stack inlet temperature map in FIG. 3. The present invention controls the 3-way proportional valve 13 by a multi-point temperature control method based on the operating conditions of the vehicle to maintain the maximum power for a significantly long time and to improve the fuel efficiency in a downtown mode, compared to existing technologies.

A method for controlling a coolant temperature of a fuel cell system in accordance with an exemplary embodiment of the present invention controls the stack inlet coolant temperature to follow a target stack inlet coolant temperature by a proportional-integral (PI) control during the control of the thermal management system for the fuel cell system. Here, the target stack inlet coolant temperature may vary depending on the outdoor temperature.

For example, the target stack inlet temperature may vary from 56 to 66° C., and this target stack inlet coolant temperature is a control signal transmitted from the FCU 18 to the controller 19. The FCU 18 receives a signal from an outdoor temperature sensor to vary the target stack inlet coolant temperature based on the outdoor temperature, and the controller 19 controls the opening degree of the 3-way proportional valve 13 based the control signal received from the FCU 18 so that the stack inlet coolant temperature T_FC follows the target stack inlet coolant temperature T_FC_Target.

The control of the opening degree of the 3-way proportional valve 13 effectuated made by the electric actuator 20 mounted on the 3-way proportional valve 13, and the electric actuator 20 receives a signal from the controller 19 to control the operation of the coolant flow control valve mounted in the valve housing 21 to control the flow rate of coolant passing through the bypass line 17 and the radiator 12, thus controlling the stack inlet coolant temperature T_FC.

For example, in order to increase the stack inlet coolant temperature T_FC, the 3-way proportional valve 13 increases the opening degree of the first coolant inlet 22, which passes through the bypass line 17, more than the opening degree of the second coolant inlet 23, which passes through the radiator 12, such that a larger amount of relatively high temperature coolant passing through the bypass line 17 is supplied to the inlet of the fuel cell stack 11.

Moreover, in order to reduce the stack inlet coolant temperature T_FC, the 3-way proportional valve 13 increases the opening degree of the second coolant inlet 23, which passes through the radiator 12 more than the opening degree of the first coolant inlet 22, which passes through the bypass line 17, such that a larger amount of relatively low temperature coolant passing through the radiator 12 is supplied to the inlet of the fuel cell stack 11. Of course, in order to increase or reduce the stack inlet coolant temperature T_FC more sharply, it is possible to selectively open and close the first coolant inlet 22 and the second coolant inlet 23.

The method for controlling the target stack inlet coolant temperature based on the outdoor temperature will be described below. For example, when the outdoor temperature rises to into higher temperatures in the summer, the difference between the operation temperature of the fuel cell system and the outdoor temperature is relatively less than that in the winter. And when the temperature difference is small, the heat dissipation rate of the fuel cell system is relatively small due to the outdoor temperature, and thus it is possible to reduce the operation temperature of the fuel cell system by reducing the target stack inlet coolant temperature to reduce the stack inlet coolant temperature by means of the 3-way proportional valve 13. At this time, the 3-way proportional valve 13 increases the amount of low temperature coolant passing through the radiator 12 and supplies the coolant to the inlet of the fuel cell stack 11.

Moreover, when the outdoor temperature is reduced to lower temperatures in the winter, the difference between the operation temperature of the fuel cell system and the outdoor temperature is relatively greater than that in the summer And when the temperature difference is large, the heat dissipation rate of the fuel cell system is relatively large due to the outdoor temperature, and thus it is possible to increase the operation temperature of the fuel cell system by increasing the target stack inlet coolant temperature to increase the stack inlet coolant temperature by means of the 3-way proportional valve 13.

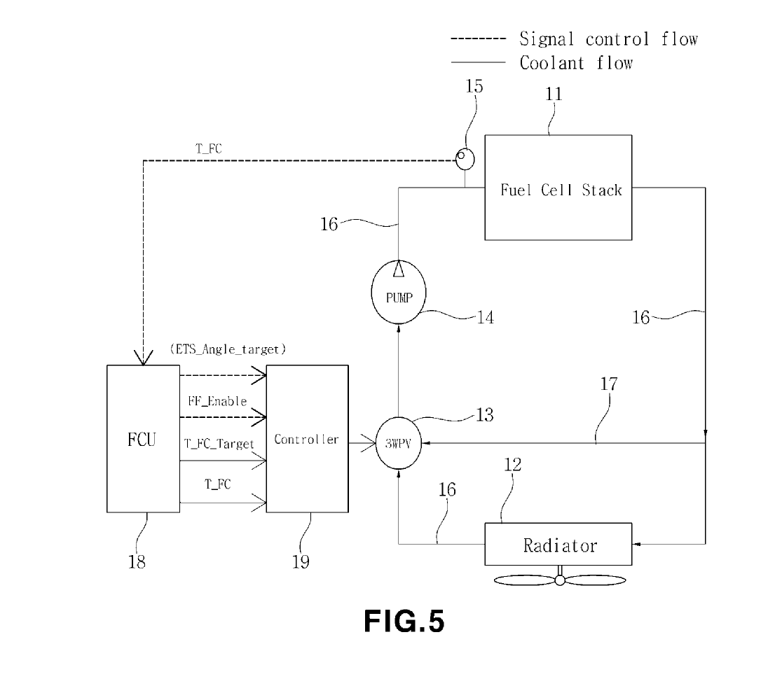

FIG. 5 is a structure diagram showing a stack heat generation rate-based feedforward control in accordance with another exemplary embodiment of the present invention. A method for controlling a coolant temperature of a fuel cell system in accordance with another exemplary embodiment of the present invention proactively controls the 3-way proportional valve 13 by a stack heat generation rate-based feedforward control to prevent the temperature of the fuel cell stack from rising when significant power is required during acceleration and quick start.

A feedforward control refers to a control method in which the FCU 18, a high level controller, transmits an opening command directly to the 3-way proportional valve 13 to reduce the valve opening time. In other words, the FCU 18 further transmits an opening command ETS_Angle_Target as well as the target stack inlet coolant temperature, and the controller 19 receives the corresponding signal from the FCU 18 to control the opening of the 3-way proportional valve 13 to follow an opening command value.

Here, the opening command value refers to the opening degree of the second coolant inlet 23 of the 3-way proportional valve 13. When the opening command value is greater, the opening degree of the second coolant inlet 23 is larger, and thus a larger amount of cooled coolant passing through the radiator 12 can be supplied to the inlet of the fuel cell stack 11, thus reducing the temperature of the fuel cell stack 11.

The conditions for determining the feedforward control may include three parameters such as a stack heat generation rate, a stack outlet coolant temperature, and duration of the stack heat generation rate and the stack outlet coolant temperature. The method for determining and controlling the feedforward control will be described below.

The stack heat generation rate and the stack outlet coolant temperature may be measured by the temperature sensors 15 mounted on the inside and the outlet of the fuel cell stack 11, respectively, and the duration of the stack heat generation rate and the stack outlet coolant temperature may be measured by a timer and the like. Then, the FCU 18 determines whether to enter the feedforward control based on the stack heat generation rate, the stack outlet coolant temperature and the duration of the stack heat generation rate and the stack outlet coolant temperature.

When the stack heat generation rate measured by the temperature sensor 15 is greater than a reference value P1 (a first entry condition: stack heat generation rate≧P1), when the stack outlet coolant temperature is greater than a reference value T1 (a second entry condition: stack outlet coolant temperature≧T1), and when the duration of the stack heat generation rate and the stack outlet coolant temperature lasts for a predetermined time S1 (a third entry condition: duration=S1), the feedforward (FF) control is turned on. When all of the above three conditions are not satisfied, the FF control is turned off.

Subsequently, when the FF control is turned on, the FCU 18 generates an FF opening command value and transmits a control signal corresponding to the opening command value to the controller 19. Then, the controller 19 receives the control signal from the FCU 18 and controls the 3-way proportional valve 13 to follow the opening command value. Here, a final opening command value includes a target stack inlet coolant temperature-based PI control (i.e., a target temperature-based PI control) calculation value and an FF control command value.

Further, the opening of the 3-way proportional valve 13 allows the target stack inlet coolant temperature-based PI control to be performed after reaching the FF control command value. That is, during the FF control, the actual opening of the 3-way proportional valve 13 is controlled not to be less than the FF opening command value. Here, the stack heat generation rate, the stack outlet coolant temperature, the duration, and the FF control value used to determine whether to enter the FF control may vary depending on the outdoor temperature.

For example, when the outdoor temperature rises, the reference value P1 for the stack heat generation rate may be reduced, the reference value T1 for the stack outlet coolant temperature may be reduced, the duration S1 of the stack heat generation rate and the coolant temperature may be reduced, the duration S2 for the FF control off may be increased, and the FF control value may be increased.

As described above, the apparatus and method for controlling the coolant temperature of the fuel cell system according to the present invention has the following advantages.

First, the opening of the 3-way proportional valve is not controlled based on a specific temperature (i.e., a one-point temperature control) but is instead controlled based on various temperatures (i.e., a multi-point temperature control) in view of the outdoor temperature, the power of the vehicle, the operation mode (e.g., downtown), etc., and thus it is possible to prevent a deviation in fuel efficiency for each season and for each operation mode (downtown, highway, etc.) and improve the fuel efficiency by controlling the 3-way proportional valve based on the vehicle operation conditions.

Second, the valve opening time can be reduced by the forced opening of the valve through the stack heat generation rate-based feedforward control, and thus it is possible to increase the maximum power duration (e.g., 45 seconds) of the vehicle in the summer season compared to conventional technologies (e.g., 3 second) and prevent shutdown due to overheating.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

1.-3. (canceled)

4. A method for controlling a coolant temperature of a fuel cell system, the method comprising:
measuring, by a sensor, the coolant temperature at an inlet of a fuel cell stack;
variably controlling, by a fuel cell controller, a target stack inlet coolant temperature based on a control factor;
comparing, by the fuel cell controller, a measured value of the stack inlet coolant temperature and a predetermined value of the target stack inlet coolant temperature; and
controlling by the fuel cell controller, when the measured value of the stack inlet coolant temperature is greater than the predetermined value of the target stack inlet coolant temperature, an opening degree of a 3-way proportional valve to follow a target coolant temperature via sending a control signal to a controller,
wherein an operation temperature of the fuel cell system is controlled through a multi-point temperature control based on power of a vehicle and an outdoor temperature (i.e., heat dissipation performance) for each season to improve fuel efficiency.

5. The method of claim 4, wherein the target coolant temperature varies depending on the outdoor temperature.

6. The method of claim 4, wherein the target coolant temperature varies depending on a stack heat generation rate, a stack outlet coolant temperature, and a duration of the stack heat generation rate and the stack outlet coolant temperature.

7. The method of claim 4, further comprising:
measuring a stack heat generation rate, a stack outlet coolant temperature, and a duration of the stack heat generation rate and the stack outlet coolant temperature; and
receiving, at a fuel cell controller, the stack heat generation rate, the stack outlet coolant temperature, and the duration of the stack heat generation rate and the stack outlet coolant temperature and, when the stack heat generation rate, the stack outlet coolant temperature, and the duration of the stack heat generation rate and the stack outlet coolant temperature satisfy control entry conditions, directly controlling the opening degree of the 3-way proportional valve through a feedforward control to follow an opening command value.

8. The method of claim 7, wherein the control entry conditions are established by comparing the stack heat generation rate, the stack outlet coolant temperature, and the duration of the stack heat generation rate and the stack outlet coolant temperature with a reference value thereof, respectively.

9. The method of claim 7, wherein the stack heat generation rate, the stack outlet coolant temperature, the duration of the stack heat generation rate and the stack outlet coolant temperature opening, and the opening command value are variable depending on the outdoor temperature.

10.-12. (canceled)
